(19) United States
(12) Patent Application Publication
(10) Pub. No.: US 2011/0189373 A1
(43) Pub. Date: Aug. 4, 2011

(54) LOW PROTEIN AND PROTEIN-FREE LIQUID, LIQUID CONCENTRATE AND POWDER CREAMERS, AND PROCESS OF MAKING THEREOF

(75) Inventors: Christine Ann Beeson, Marysville, OH (US); Ken Robert Erickson, Dublin, OH (US); Alexander A. Sher, Dublin, OH (US)

(73) Assignee: NESTEC S.A., Vevey (CH)

(21) Appl. No.: 13/122,699

(22) PCT Filed: Oct. 6, 2009
(86) PCT No.: PCT/EP2009/062934

§ 371 Date: Apr. 5, 2011

Related U.S. Application Data
(60) Provisional application No. 61/103,045, filed on Oct. 6, 2008.

(51) Int. Cl. A23L 2/00; A23G 1/00; A23F 5/00; A23F 3/00; A23D 7/00

(52) U.S. Cl. 426/593; 426/590; 426/594; 426/597; 426/599; 426/601

(57) ABSTRACT

The invention provides low protein and protein-free creamer compositions, and processes for making them. The creamer composition includes an emulsifying component of at least one emulsifier; a buffer system of at least one buffering agent; and a chelating system of at least one chelating agent of an organic acid or organic acid salt. The creamer optionally contains a whitening agent in an amount sufficient to provide additional whitening to an aqueous media to which the creamer is added. The composition has a fat or oil content of about 0.5% to about 50% by weight and a protein content of no more than 3% by weight. The creamer composition can be in the form of liquid, liquid concentrate or powder, and provides high whitening capacity and a pleasant mouth-feel with no discernable feathering or fat separation when added to aqueous media of beverages at different pHs, hardnesses and temperatures.

### FIELD OF INVENTION

The present invention relates to compositions for non-dairy, extended-shelf-life (ESL) and aseptically packaged liquid creamer, liquid creamer concentrates and powder creamer, and to the processes for making them.

### BACKGROUND OF THE INVENTION

Creamers are used as whitening agents with hot and cold beverages such as coffee, cocoa, and tea. Creamers are also used in the powder or particulate form as replacement for milk or cream, with cereal or in cooking, for example. Creamers are available in different flavors and often vary in terms of desired qualities such as mouth-feel, body, and texture.

Creamers (or whiteners) are available in liquid, liquid concentrate or powder forms. Liquid and powder creamers are widely used in retail and food service applications. Liquid concentrate and powder creamers are also used as a component of liquid or powder beverages, or in dispensing systems.

Fresh or refrigerated dairy creamers usually provide a good mouth-feel, but their tendency to spoil rapidly, even under refrigeration conditions, makes their use inconvenient. This disadvantage can be overcome by a non-dairy creamer, but the challenge still remains to create a homogeneous extended-shelf-life (ESL) or aseptic liquid product which has constant manageable viscosity and is stable during storage for several months at both refrigerated and ambient temperatures. The main challenges for powder creamers are good emulsion stability during the process of making and good solubility when added to beverages, without de-oiling, feathering, sedimentation and other physico-chemical instability issues.

The market of non-dairy coffee creamers as coffee whiteners is rapidly growing, and the US is the market leader for this type of product. There is also an increased demand for low-fat and non-fat creamers. Because fat helps achieve emulsion, it is an added challenge to provide a creamer that has low or no fat, with the desired stability, color, texture, body, and flavor.

When added to cold or hot beverage such as coffee, the creamer should provide a good whitening capacity, dissolve rapidly, and remain stable with no de-oiling, feathering and/or sedimentation, and provide a superior taste. It is noted that physical stability is particularly difficult to achieve in a hot, acidic environment as well as when hard water is used in beverage preparation.

Several patents, such as European patent application No. 0 457 002 and U.S. Pat. No. 3,935,325 describe coffee creamers that are made of water, vegetable oil, protein or protein hydrolysate, carbohydrates, buffering salt, emulsifiers and other ingredients. However, these coffee whiteners are not shelf-stable.

U.S. Pat. No. 4,748,028 discloses an aseptic fluid coffee whitener and process for preparing the same. The process includes performing ultra-high temperature (UHT) sterilization of a mixture of water, vegetable fat, emulsifiers, a milk protein, salt and other ingredients; cooling; homogenizing; and further cooling; and filling the resulting liquid in an aseptic container under aseptic conditions. The main disadvantage of this coffee whitener is the high level of fat in the creamer, and the insufficient whitening power of the creamer with a reduced fat level. The creamer is also stable against browning only under refrigeration conditions (up to 4 months).

U.S. Pat. No. 4,784,865 describes dairy coffee whitener including low fat milk, non fat dry milk, an emulsifier that is preferably made of mono- or di-glycerides, and TiO₂ as a whitening agent. The product is pasteurized and remains stable under refrigerated and non-refrigerated conditions for at least 90 and 30 days, respectively. Because the whitener lacks any stabilizing systems, severe sedimentation of TiO₂ during the storage can be expected. Further, this product is not aseptically processed, so an extended-shelf-life (at least 6 months) cannot be achieved.

U.S. Pat. No. 5,571,334 patent describes a starch-based opacifying agent, methods of manufacture thereof, and food and non-food formulations containing the opacifying agent. The agent includes an opacifier (e.g. TiO₂) incorporated in a starch matrix. However, the creamer in the disclosure is not aseptically processed, so an extended-shelf-life (at least 6 months) cannot be achieved. Moreover, a large amount of sodium caseinate is used to achieve emulsion stability of the creamer.

PCT application WO 2007/044782 describes an non-dairy, aseptic liquid creamer with an emulsifier level of at least 1% in order to achieve a stable emulsion. The emulsifiers are combined with a milk protein such as calcium caseinate, sodium caseinate, or potassium caseinate in order to achieve stability of the creamer.

In sum, presently existing creamer technology requires the use of proteins, usually at very high levels, to achieve emulsion stability. Proteins are known as strong emulsifiers and milk proteins, such as casein, sodium caseinate and whey proteins, are preferred due to their unique emulsifying properties. However, addition of proteins to ultra-high temperature (UHT) treated liquid coffee creamers may lead to sedimentation due to protein denaturation and lower water solubility of the proteins or their derivatives. Further, proteins in powder creamers may lead to sedimentation and flocculation after creamer reconstitution in hot beverages, especially in acidic environments. Additionally, competition between proteins and low molecular weight emulsifiers may lead to emulsion instability resulting in product creaming.

Another disadvantage in using proteins such as casein and sodium caseinate in creamers is clumping in ESL or aseptic liquid creamers during storage. For instance, a “plug” may form overnight when the creamer is stored at refrigerated, room, or elevated temperatures, making pouring difficult and the product unusable. Furthermore, when added to coffee, feathering may result from emulsion instability of the protein in this hot, acidic environment, especially in the presence of Ca²⁺ and /or Mg²⁺ ions.

Finally, with the increasing cost of proteins such as casein, the reduction or elimination of proteins in creamers is desirable. The challenge in creating a low or no protein creamer is to achieve a stable emulsion without phase separation (e.g. creaming, gelation, syneresis) during storage and after reconstitution in beverages, especially in hot and acidic beverages.

Thus, there is a need for ESL and aseptic liquid creamers, liquid creamer concentrates and powder creamers that have low or no protein, but still maintain the desired properties of fresh creamers. Specifically, such low protein or protein-free creamers must have good physico-chemical stability (without creaming and sedimentation) throughout their shelf life, and a pleasant mouth-feel (without feathering and fat separation) when added to liquid beverages such as coffee and tea.

### SUMMARY OF THE INVENTION

The invention set forth herein satisfies the unmet needs of the art by providing a non-dairy, low protein or protein-free creamer composition comprising an emulsifying component comprising at least one emulsifier, a buffer system comprising at least one buffering agent, and a chelating system comprising at least one chelating agent of an organic acid or organic acid salt. The composition optionally includes a whitening agent in an amount sufficient to provide additional whitening to an aqueous media to which the creamer is added. Advantageously, the composition has a fat or oil content of about 0.5% to about 50% by weight of the composition and a protein content of no more than 3% by weight of the composition. These compositions provide high whitening capacity and a pleasant mouth-feel with no discernable feathering or fat separation when added to aqueous media of beverages at different pHs, hardnesses and temperatures.

The creamer of the invention can be in the form of (a) an aseptic liquid or liquid concentrate creamer that is stable at ambient temperatures for at least about nine months before opening; (b) a liquid or liquid concentrate creamer that has an extended-shelf-life (ESL) and is stable for at least about two months at refrigeration temperatures; or (c) a powder creamer that is stable for at least about twenty-four months at ambient temperatures. The creamer of the invention has either no protein or a protein content of no more than 3% by weight of the composition. In liquid or liquid concentrate creamer compositions of the invention, the total solids content is in the range of 5% to 80% by weight of the composition while the total solids content is in the range of 94% to 99% by weight of the composition in powder creamer compositions of the invention. The creamer composition of the invention further comprises fat or vegetable oil.

In an embodiment of the creamer of the invention, the at least one emulsifier is a medium Hydrophobic/Lipophilic Balance (HLB) emulsifier present in an amount of 0.05% to 3.5% by weight of the composition. Preferably, the medium HLB emulsifier comprises a glyceride compound such as succinylated monoglyceride, succinylated di-glyceride or a combination thereof. Preferably, when a combination is used, the di-glycerides are present in an amount of 0.01% to 25% by weight of the total glycerides in the composition. The fatty acid chain length in the succinylated di-glyceride is from C-4 to C-24.

In another embodiment of the invention, the at least one buffering agent is a food grade salt of organic or inorganic acid selected from the group consisting of potassium phosphate, dipotassium phosphate, tripotassium phosphate, sodium phosphate, disodium phosphate, trisodium phosphate, sodium tripolyphosphate, potassium tripolyphosphate, tetra sodium pyrophosphate, tetra potassium pyrophosphate, sodium hexametaphosphate, potassium carbonates, sodium carbonates, potassium bicarbonates, sodium bicarbonates, sodium or potassium acetate, sodium or potassium ascorbate, and a combination thereof, or in combination with organic or inorganic acid, and is present in an amount of 0.05% to 3.5% by weight of the composition.

In a preferred embodiment of the invention, the at least one chelating agent is citric, sodium citrate, tri-sodium citrate, potassium citrate, tri-potassium citrate, EDTA, sodium or potassium salts of EDTA, phytic, malic, succinic, tartaric acids or sodium and potassium salts of the acids, or a combination thereof, and is present in an amount of 0.02% to 3% by weight of the composition.

The creamers can either be low protein or protein free. In the low protein creamer compositions of the present invention, the weight ratio of the emulsifier to oil is in the range from 0.05:1 to 5:1; the buffering agent and the emulsifier are present in a weight ratio of between 0.1:1 to 20:1; and the weight ratio of the chelating agent to the emulsifier is in the range from 0.1:1 to 15:1. Combinations of these ratios may be present for optimum results.

In the protein-free creamer compositions of the invention, the weight ratio of the emulsifier to oil is in the range from 0.1:1 to 4.5:1; the weight ratio of the buffering agent to the emulsifier is from 0.5:1 to 10: 1; and the weight ratio of the chelating agent to the emulsifier is from 0.5:1 to 10: 1. Combinations of these ratios may be present for optimum results.

In these creamers, the protein may be present and casein is conveniently included for this purpose. When the oil or fat is present in an amount of about 0.5% to about 20%, up to 1 to 1.5% casein may be used, while 20% to 50% oil or fat could be present with up to 1.5 to 2% casein, with the higher amounts of casein corresponding to the higher amounts of oil or fat. Alternatively, the oil or fat to casein ratio may be 40:1 to 60:1 for creamers with 0.5% to 20% oil or fat, and 50:1 to 60:1 for creamers with 20% to 50% oil or fat.

In a preferred embodiment of the invention, the creamer is in the form of a powder creamer and has a particle size of about 100 to about 4000 microns.

When a whitener is used, a preferred one is titanium dioxide having a particle size of about 0.1 to about 0.7 microns with a mean particle size of 0.3 microns, and is present in an amount of about 0.1 to about 1 percent by weight of the composition.

The invention further provides for a beverage comprising an aqueous liquid, a beverage-forming component such as coffee, tea, chocolate or a fruit drink, and the creamer of the invention in an amount sufficient to provide a creaming effect to the beverage. The creamer of the invention can also be used as a dairy replacement for consumption with food or for use in cooking. The creamer of the invention may further comprise at least one food grade preservative selected from the group consisting of sodium benzoate, potassium benzoate, sorbic acid, sodium sorbate, potassium sorbate, sulfites, and combinations thereof.

The invention further provides for a process of manufacture of the creamer of the invention comprising providing the emulsifying component, the buffering agents and the chelating agents, in powder form or liquid form, or a combination thereof; and dissolving the powder components in water with agitation. The water may be cold, hot, or cold and then heated, or hot and then cooled. In one embodiment, this process further comprises adding a sweetener or whitening agent, in powder form or liquid form, or a combination thereof, into the water with agitation. Additionally, vegetable oil or fat can be added to the water to produce a mixture of all components, followed by subjecting the mixture to a heat treatment selected from the group consisting of ultra-high temperature (UHT) pasteurization or sterilization, retorting and other thermoprocessing procedures, homogenization, cooling, and then either filling in containers under aseptic conditions to produce liquid or liquid concentrate creamers, or drying to a powder and filling the powder into containers under aseptic conditions to produce powder creamers.

### DETAILED DESCRIPTION OF THE PREFERRED EMBODIMENTS

It is well known that for stable oil in water emulsion, emulsifiers with high Hydrophobic/Lipophilic Balance (HLB) values provide the best stability. Surprisingly, the inventors found that emulsifiers with medium HLB such as glycerides selected from succinylated monoglycerides, succinylated di-glycerides and a combination thereof provide the best emulsion stability of liquid creamers in low and no protein environments. The present invention provides for low protein and protein free ESL and aseptic liquid creamers, liquid concentrate creamers and powder creamers by taking advantage of the novel complex stabilizing system formed by the combination of medium HLB emulsifiers, buffering agents and chelating agents. The aseptic liquid creamers of the invention are shelf-stable for at least nine months while powder creamers have a shelf-life for at least 24 months. The creamer of the invention can be used as a whitener for a liquid or powder beverage such as coffee, tea, cocoa or a fruit drink. The creamers can also be used as a dairy replacement that can be consumed directly or with cereals, as cream for berries, creamers for soups and in many other cooking applications. When the creamer of the invention is combined with coffee or other liquid beverages, the resulting liquid has a solid content of 2-15%, preferably 4-10%, most preferably 5-8%, and is consumable as a liquid beverage. Creamers of the invention can also be used as a part of other products, such as RTD beverages, 2-in-1 or 3-in-1 liquid concentrates, and 2-in-1 or 3-in-1 powder mixtures.

The novel complex stabilizing system of the invention makes it possible to use reduced level of proteins to achieve stable emulsion. For example, a low protein creamer of the invention containing from about 0.5% to about 20% oil or fat only needs 0 to 1-1.5% casein to get stable emulsion. Similarly, a low protein creamer of the invention containing from about 20% to 50% oil or fat only needs 0 to 1.5 - 2.0% casein to get stable emulsion. Thus, the oil or fat to casein ratio is 40:1 to 60:1 for creamers with 0.5% to 20% oil, and 50:1 to 60:1 for creamers with 20% to 50% oil or fat.

Preferably, the fat or oil comprises one or more fats or vegetable oils dispersed in a matrix comprising one or more protein or carbohydrate ingredient or mixtures thereof. The fat may be caloric, non-caloric, or mixtures thereof, and may include any edible natural, synthetic, or modified non-volatile lipophilic substance, including solid fat, liquid oil, fat substitute, or other water-immiscible substance, obtained or derived from any suitable plant, animal, or other source. It may be present in pure form, as part of a flavor system in the form of a non-volatile carrier liquid, or as a dispersion of emulsified or encapsulated liquid droplets, solid particles, or mixtures thereof, such as commonly occurs in spray-dried creamer and shortening powders and in encapsulated flavors. The fat may include triglycerides, diglycerides, or mixtures thereof, obtained or derived from plant or animal sources including, but not limited to, fruits, vegetables, legumes, seeds, nuts, grains, and milks. For non-dairy formulations, milk products are not used.

When present, the proteins in the creamer of the invention can include but are not limited to casein, whey, soy, wheat, egg white, their derivatives or a combination thereof. Preferably, the protein source is casein, sodium caseinate, whey protein, soy protein, their isolates or hydrolysates. Most preferably, the protein is casein and sodium caseinate.

The protein-free creamer of the invention may further contain starches, hydrocolloids, or a combination thereof.

The emulsifier component of the stabilizing system of the invention comprises at least one medium HLB value emulsifier such as a succinylated monoglyceride (succinic acid esters of monoglycerides, SMG), which is an anionic emulsifier. In addition to succinic acid esters of monoglycerides emulsifiers, the emulsifier component of the stabilizing system may also contain from about 0.01 to about 25% of succinic acid esters of di-glycerides emulsifiers having different fatty acids molecular compositions with chain length from C₄ to C₂₄, alone or in combination thereof. The oils used to produce the esters can include but are not limited to soybean oil, coconut oil, palm oil, palm kernel oil, cotton seed oil, canola oil, olive oil, sunflower oil, safflower oil, or a combination thereof.

In low protein creamers of the invention, the weight ratio of the emulsifier to oil or fat is in the range from 0.05:1 to 5:1, preferably from 0.1:1 to 2.5:1, and most preferably from 0.15:1 to 1.5:1. For protein free creamers, the weight ratio of the emulsifier to oil or fat is from 0.1:1 to 5:1, preferably from 0.15:1 to 3:1, and most preferably from 0.2:1 to 2.5:1.

The creamer of the invention comprises at least one buffering agent such as potassium phosphate, dipotassium phosphate, tripotassium phosphate, sodium phosphate, disodium phosphate, trisodium phosphate, sodium tripolyphosphate, potassium tripolyphosphate, tetra sodium pyrophosphate, tetra potassium pyrophosphate, sodium hexametaphosphate, potassium carbonates, sodium carbonates, potassium bicarbonates, sodium bicarbonates, or a combination thereof.

In low protein creamers of the invention, the weight ratio of the buffering agent to the emulsifier is in the range from 0.1:1 to 20:1, preferably from 0.5:1 to 10:1, and most preferably from 1:1 to 4:1. For protein free creamers, the weight ratio of the buffering agent to the emulsifier is in the range from 0.5:1 to 10:1, preferably from 1:1 to 5:1, and most preferably from 1.5:1 to 2.5:1.

The creamer of the invention also comprises at least one chelating agent such as citric, sodium citrate, tri-sodium citrate, potassium citrate, tri-potassium citrate, EDTA, sodium or potassium salts of EDTA, phytic, malic, succinic, tartaric acids or sodium and/or potassium salts of the acids, or a combination thereof.

In low protein creamers of the invention, the weight ratio of the chelating agent to the emulsifier is in the range from 0.1:1 to 15:1, preferably from 0.5:1 to 8:1, and most preferably from 1:1 to 3.5:1. For protein free creamers, the weight ratio of the chelating agent and the emulsifier is in the range from 0.5:1 to 10:1, preferably from 0.5:1 to 5:1, and most preferably from 1:1 to 2.5:1.

Optionally, to maximize the whitening capacity of the creamer, titanium dioxide with a main particle size around 0.3 microns can be added to the powder, concentrate and liquid creamers of the invention to take full advantage of light scattering/diffraction. The creamer can also contain sweeteners, including but not limited to sucrose, fructose, maltodextrin, high fructose corn syrup, other natural sweeteners, artificial sweeteners, or combination thereof. The sweeteners may be present in concentration from about 0.1 to 50%, and preferably from about 5 to 30% by weight of the total composition. The creamer may also contain flavor(s) and/or colorant(s).

Optionally, liquid, liquid concentrate and powder creamers of the invention may contain different flavors and colors and combinations of thereof.

Liquid and liquid concentrate creamers may have from about 5% to about 80% total solids (TC), and the powder creamers may contain from about 94% to about 99% TC. Both liquid and powder creamers may contain from about 0.1 to 50 wt % of fats or vegetable oil(s). The vegetable oil(s) may comprise partially or wholly hydrogenated oils, alone or in combination. The oils can include but are not limited to soybean oil, coconut oil, palm oil, palm kernel oil, cotton seed oil, canola oil, olive oil, sunflower oil, safflower oil and other oils, or a combination thereof.

Liquid and concentrate creamers of the invention have manageable viscosity without phase separation such as creaming, sedimentation and age gelation, during different storage conditions over the full life of the product. According to the present invention, the low protein and protein free non-dairy aseptic and ESL liquid creamers and liquid concentrates are homogeneous and have manageable viscosity during the ambient storage for several months without phase separation, gelation and sedimentation. The low protein and protein free powder creamers survive harsh conditions during the process of making, e.g. high shear stress and temperature effect during spray drying.

Sensory evaluation of coffee with the creamer of the invention showed good mouth-feel, full body, smooth texture, and a good taste with no off flavors and undesirable aftertaste. Specifically, such protein free powder creamer of the invention showed no off taste notes even after 2 months storage at room temperatures.

The present invention further provides a process of making the liquid creamer or creamer concentrate of the invention, which includes providing the emulsifying component, the buffering agents and the chelating agents, in powder form and dissolving the powdered components in water under agitation. Other optional components such as sweetener or whitening agent, in powder form, can also be included in this step. Next, melted oil/fat is added to the hot water to produce a mixture of all components. The mixture then undergoes UHT treatment, homogenization, cooling, and filling in aseptic containers under aseptic conditions. Homogenization can be performed before and/or after heat treatment.

The present invention further provides a process of making low protein or protein-free powder creamer of the invention, which includes dissolving the powder components in water under agitation, addition of melted fat/oil, followed by pasteurization, homogenization, drying, cooling, and filling. The powder creamer can have a particle size of about 100 to about 4000 microns, preferably 500 to 3000 microns, and most preferably about 1000 to 2000 microns. The powder creamer can be bed dried, spray dried, freeze dried, agglomerated, or prepared in accordance with other techniques as known in the art. For example, the powder creamer of the invention can be made by spray drying of 60-80% (w/w) liquid feed and contain up to about 5% of moisture in the final products.

The advantages of the present invention are numerous. First of all, the invention achieves a low protein or protein-free, true non-dairy creamer, with limited use or no use of casein or its derivatives but having high whitening capacity and pleasant mouth-feel. Additionally, liquid creamers of the invention achieve superior physico-chemical stability (a shelf life of at least nine months), with no phase separation such as creaming, gelation, syneresis, or sedimentation, during storage at refrigeration (˜4° C.) or at room and elevated temperatures (e.g. 30° C., 38° C.). Moreover, creamers of the invention do not oxidize or discolor for at least nine months at refrigeration and room temperatures, and thus provides high whitening capacity even without fat. Furthermore, creamers of the invention are easily dispersible in beverages such as coffee and tea, and are stable even in hot, acidic and high Ca²⁺ and Mg²⁺ environments. Importantly, the reduction or even elimination of the need for milk proteins such as casein also provides a significant cost reduction. Additionally, when titanium dioxide is used as a complementary whitener, the TiO₂ is maintained in full suspension throughout the liquid or liquid concentrate creamer shelf-life under all temperature conditions.

### EXAMPLES

### Example 1

Corn syrup solids (1.2 kg) were dissolved in water at 180° F. under high agitation, and then dipotassium phosphate (0.3 kg) and sodium citrate (0.3 kg) were added to the solution. Oil (0.2 kg) was melted at 140° F. and SMG (0.1 kg) was added to the liquefied oil under high agitation. The oil/emulsifier mixture was added to above corn syrup solution and mixed under continuous agitation.

The resulted liquid was re-heated at HTST conditions for 2 sec at 180° F., homogenized at 1000/500 psi. Directly after heat treatment, the resulting liquid concentrate processed through conventional spray drier, and dried creamer in powder form was collected.

Product was placed into airtight container and stored at ambient conditions. Sensory characteristics of coffee with added coffee creamer was judged by six non-trained panelists, who found the product having good mouth-feel, full body, smooth texture, and a good flavor with no off-taste.

### Example 2

Coffee creamer was prepared as in Example 1 but using 1 kg SMG. Sensory characteristics of coffee with added coffee creamer was judged by six non-trained panelists, who found the product unacceptable having unpleasant mouth-feel with extensive bitter flavor.

### Example 3

Coffee creamer was prepared as in Example 1 but using 0.01 kg SMG. Emulsion stability of liquid mix before spray drying was poor resulting in phase separation of the liquid concentrate. Due to the instability of the concentrate, it cannot be spray dried.

The embodiments and examples illustrated and discussed in this specification are intended only to teach those skilled in the art the best way known to the inventors to make and use the invention. The above-described embodiments of the invention may be modified or varied, without departing from the invention, as easily appreciated by those skilled in the art in light of the above teachings. Accordingly, all expedient modifications readily attainable by one of ordinary skill in the art from the disclosure set forth herein, or by routine experimentation therefrom, are deemed to be within the spirit and scope of the invention as defined by the appended claims.

1. A low protein or protein-free creamer composition comprising:
an emulsifying component comprising at least one emulsifier;
a buffer system comprising at least one buffering agent; and
a chelating system comprising at least one chelating agent selected from the group consisting of an organic acid, inorganic acid, organic acid salt and inorganic acid salt;
the composition has a fat or oil content of about 0.5% to about 50% by weight of the composition and a protein content of no more than 3% by weight of the composition; and
the composition provides high whitening capacity and a pleasant mouth-feel with no discernable feathering or fat separation when added to aqueous media of beverages at different pHs, hardnesses and temperatures.

2. The composition of claim 1, wherein the emulsifier is a medium Hydrophobic/Lipophilic Balance (HLB) emulsifier comprising a glyceride compound and is present in an amount of 0.05% to 3.5% by weight of the composition, the buffering agent comprises a compound selected from the group consisting of phosphate, carbonate, acetate, and ascorbate and is present in an amount of 0.05% to 3.5% by weight of the composition; and the chelating agent is present in an amount of 0.02% to 3% by weight of the composition.

3. The composition of claim 2, wherein the emulsifier is selected from the group consisting of succinylated monoglyceride, succinylated di-glyceride and a combination thereof, wherein, when a combination is used, the di-glyceride is present in an amount of 0.01% to 25% by weight of the total glycerides in the composition.

4. The composition of claim 2, wherein the at least one buffering agent is a food grade salt of organic or inorganic acid selected from the group consisting of potassium phosphate, dipotassium phosphate, tripotassium phosphate, sodium phosphate, disodium phosphate, trisodium phosphate, sodium tripolyphosphate, potassium tripolyphosphate, tetra sodium pyrophosphate, tetra potassium pyrophosphate, sodium hexametaphosphate, potassium carbonates, sodium carbonates, potassium bicarbonates, sodium bicarbonates, sodium or potassium acetate, sodium or potassium ascorbate, and a combination thereof.

5. The composition of claim 2, wherein the chelating agent is selected from the group consisting of citric, sodium citrate, tri-sodium citrate, potassium citrate, tri-potassium citrate, EDTA, sodium or potassium salts of EDTA, phytic, malic, succinic, tartaric acids or sodium and potassium salts of the acids, and combinations thereof.

6. The composition of claim 2, wherein the composition comprises about 0.1 to 2% casein.

7. The composition of claim 1, wherein the composition is in the form of an aseptic liquid or liquid concentrate creamer that has a total solids content in the range of 5% to 80% by weight of the composition and is stable at ambient temperatures for at least about nine months before opening.

8. The composition of claim 1, in the form of a low protein creamer having:
a weight ratio of the emulsifier to oil in the range from 0.05:1 to 5:1;
a weight ratio of the buffering agent to the emulsifier of between 0.1:1 to 20:1; and
a weight ratio of the chelating agent to the emulsifier of 0.1:1 to 15:1.

9. The composition of claim 1 in the form of a protein free creamer having:
a weight ratio of the emulsifier to oil of at least 0.1:1 to 4.5:1;
a weight ratio of the buffering agent to the emulsifier of at least 0.5:1 to 20:1; and
a weight ratio of the chelating agent to the emulsifier of at least 0.5:1 to 15:1.

10. A beverage comprising an aqueous liquid, a beverage-forming component, and the creamer composition of claim 1 in an amount sufficient to provide a creaming effect to the beverage.

11. The beverage of claim 16 wherein the beverage-forming component is selected from the group consisting of coffee, tea, chocolate and a fruit drink.

12. A dairy replacement comprising a low protein or protein-free creamer composition comprising:
an emulsifying component comprising at least one emulsifier;
a buffer system comprising at least one buffering agent; and
a chelating system comprising at least one chelating agent selected from the group consisting of an organic acid, inorganic acid, organic acid salt and inorganic acid salt;
the composition has a fat or oil content of about 0.5% to about 50% by weight of the composition and a protein content of no more than 3% by weight of the composition; and
the composition provides high whitening capacity and a pleasant mouth-feel with no discernable feathering or fat separation when added to aqueous media of beverages at different pHs, hardnesses and temperatures and is designed for consumption with food or for use in cooking.

13. A method of manufacturing A low protein or protein-free creamer composition comprising: an emulsifying component comprising at least one emulsifier, a buffer system comprising at least one buffering agent, and a chelating system comprising at least one chelating agent selected from the group consisting of an organic acid, inorganic acid, organic acid salt and inorganic acid salt, the composition has a fat or oil content of about 0.5% to about 50% by weight of the composition and a protein content of no more than 3% by weight of the composition, and the composition provides high whitening capacity and a pleasant mouth-feel with no discernable feathering or fat separation when added to aqueous media of beverages at different pHs, hardnesses and temperatures comprising:
providing the emulsifying component, the buffering agents and the chelating agents, in powder or liquid form, or a combination thereof; and
dissolving the components in water under agitation.

14. The method of claim 13, comprising adding a sweetener or whitening agent, in powder or liquid form, or a combination thereof, into the water with agitation.

15. The method of claim 13, comprising adding a vegetable oil or fat to the water to produce a mixture of all components, followed by subjecting the mixture to a heat treatment, homogenization, cooling, and filling in containers under aseptic conditions.

16. The method of claim 13, comprising adding a vegetable oil or fat to the water to produce a mixture of all components, followed by subjecting the mixture to a heat treatment, homogenization, cooling, drying to a powder and filling the powder into containers.

17. The composition of claim 1 comprising a whitening agent in an amount sufficient to provide additional whitening to an aqueous media to which the creamer is added.

18. The composition of claim 1, wherein the composition is in the form of a liquid or liquid concentrate creamer that has a total solids content in the range of 5% to 80% by weight of the composition and an extended shelf life (ESL) such that it is stable for at least about two months at refrigeration temperatures.

19. The composition of claim 1, wherein the composition is in the form of a powder creamer that has a particle size of about 100 to about 4000 microns, a total solids content in the range of 94% to 99% by weight of the composition and is stable for at least about twenty-four months at ambient temperatures.
